(19) United States
(12) Patent Application Publication
(10) Pub. No.: US 2015/0225035 A1
(43) Pub. Date: Aug. 13, 2015

(54) BICYCLE STEM

(71) Applicant: Mu-Rong Li, Taichung City (TW)

(72) Inventor: Mu-Rong Li, Taichung City (TW)

(21) Appl. No.: 14/174,844

(22) Filed: Feb. 7, 2014

(51) Int. Cl. B62K 21/12

(52) U.S. Cl. CPC B62K 21/12

(57) ABSTRACT

A bicycle stem, which is adapted to be mounted between a handlebar and a steering tube of a bicycle, includes a body and a clamping member. The body has a clamping end and a connecting end. The connecting end of the body has a through hole for accommodating the steering tube. The body defines a pair of sliding grooves on a top thereof. The clamping member has a hook grip portion and a blade portion extending from one end of the hook grip portion. The blade portion of the clamping member has a pair of sliding protrusions formed on a bottom and slid into the sliding grooves of the body so that the clamping member is slidably mounted to the body. Under this arrangement, the hook grip portion of the clamping member cooperates with the clamping end of the body to clamp the handlebar.

### BACKGROUND OF THE INVENTION

1. Field of the Invention

The present invention relates to a bicycle component, and more particularly to a bicycle stem which is assembled easily.

2. Description of Related Art

Bicycle stem is a component on a bicycle that connects a bicycle handlebar to a steering tube of a bicycle fork. A conventional bicycle stem comprises a stem body, a clamping member and a plurality of fasteners. The stem body has one end connected to the steering tube and a connection end corresponding to the clamping member. The clamping member cooperates with the connection end of the stem body to clamp the bicycle handlebar. Wherein, the clamping member is fixed to the connection end of the stem body by the fasteners so as to secure the handlebar to the stem body.

While in operation, the bicycle handlebar should be secured to the stem by the clamping member. However, the clamping member cannot be attached to the stem body beforehand. Therefore, a rider should hold the clamping member while assembling the bicycle handlebar that is inconvenient for the rider to operate easily.

The present invention has arisen to mitigate and/or obviate the disadvantages of the conventional bicycle stem.

### SUMMARY OF THE INVENTION

The main objective of the present invention is to provide an improved bicycle stem.

To achieve the objective, a bicycle stem, which is adapted to be mounted between a handlebar and a steering tube of a bicycle, comprises a body and a clamping member. The body has a clamping end corresponding to the handlebar and a connecting end to be mounted on the steering tube. The connecting end of the body has a through hole for accommodating the steering tube. The body defines a pair of sliding grooves in a top thereof and each extending from the clamping end to the connecting end. Each of the sliding grooves has an inlet at the clamping end of the body. The clamping member has a hook grip portion and a blade portion extending from one end of the hook grip portion. The blade portion of the clamping member has a pair of sliding protrusions formed on a bottom and slid into the sliding grooves of the body so that the clamping member is slidable relative to the body.

Under this arrangement, the hook grip portion of the clamping member cooperates with the clamping end of the body to clamp the handlebar.

Furthermore, the clamping end of the body defines a positioning notch at a lower edge thereof; and the hook grip portion of the clamping member has a bump protruding from the other end thereof which fits in the positioning notch of the clamping end of the body so as to retain the clamping member on the body. Specifically, the body has a receiving groove defined in the top thereof; the receiving groove of the body has an opening at the clamping end of the body. The blade portion of the clamping member and the body together define a passage therebetween at the connecting end of the body and communicating with the receiving groove of the body. In addition, the body has a cavity defined in a bottom thereof and communicating with the receiving groove of the body and a lid member is pivotally mounted on the bottom of the body for covering the cavity

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a bicycle stem of the present invention;

FIG. 2 is another perspective view of the bicycle stem of FIG. 1 taken from another angle;

FIG. 3 is an exploded perspective view of the bicycle stem of FIG. 1;

FIG. 4 illustrates that the clamping member is slidable relative to the body of the bicycle stem of FIG. 1;

FIG. 5 is a cross-sectional view of the bicycle stem along line V-V of FIG. 2;

FIG. 6 is another perspective view of the bicycle stem of FIG. 2 taken from another angle;

FIG. 7 is an exploded perspective view of the bicycle stem of FIG. 6; and

FIG. 8 illustrates that the bicycle stem of FIG. 1 is mounted between a handlebar and a steering tube.

### DETAILED DESCRIPTION OF THE INVENTION

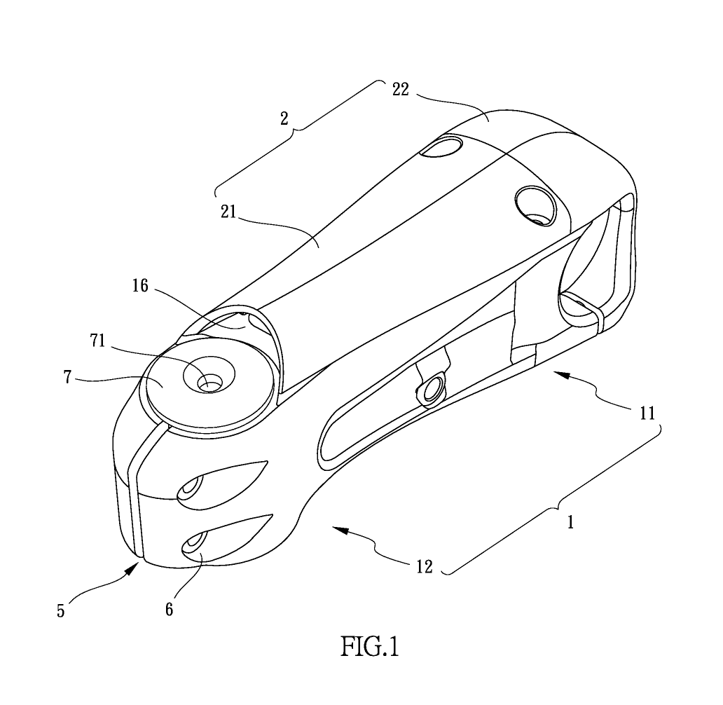

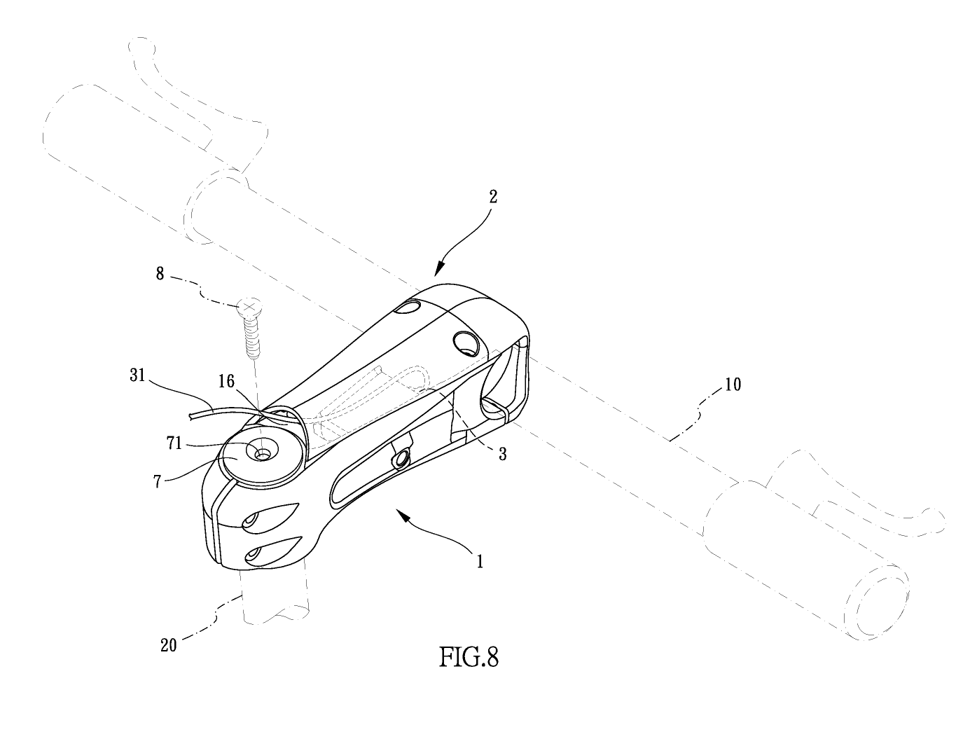

Referring to FIGS. 1-4, a bicycle stem in accordance with a preferred embodiment of the present invention, that is adapted to be mounted between a handlebar 10 and a steering tube 20 of a bicycle, as shown in FIG. 8. The bicycle stem comprises a body 1 and a clamping member 2.

The body 1 has a clamping end 11 at one end corresponding to the handlebar 10 and a connecting end 12 at the other end to be mounted on the steering tube 20. The connecting end 12 of the body 1 has a through hole 121 for accommodating the steering tube 20 so that the body 1 is mounted on the steering tube 20. Specifically, the body 1 defines a pair of sliding grooves 13 in a top thereof and each extending from the clamping end 11 to the connecting end 12. Each of the sliding grooves 13 has an inlet 131 at the clamping end 11 of the body 1.

The clamping member 2 has a hook grip portion 22 and a blade portion 21 extending from one end of the hook grip portion 22. The blade portion 21 of the clamping member 2 has a pair of sliding protrusions 211 formed on a bottom thereof. Each of the sliding protrusions 211 of the blade portion 21 of the clamping member 2 could be slid into the respective sliding groove 13 of the body 1 via the inlet 131 so that the clamping member 2 could be slidable relative to the body 1. Under this arrangement, the hook grip portion 22 of the clamping member 2 cooperates with the clamping end 11 of the body 1 to clamp the handlebar 10.

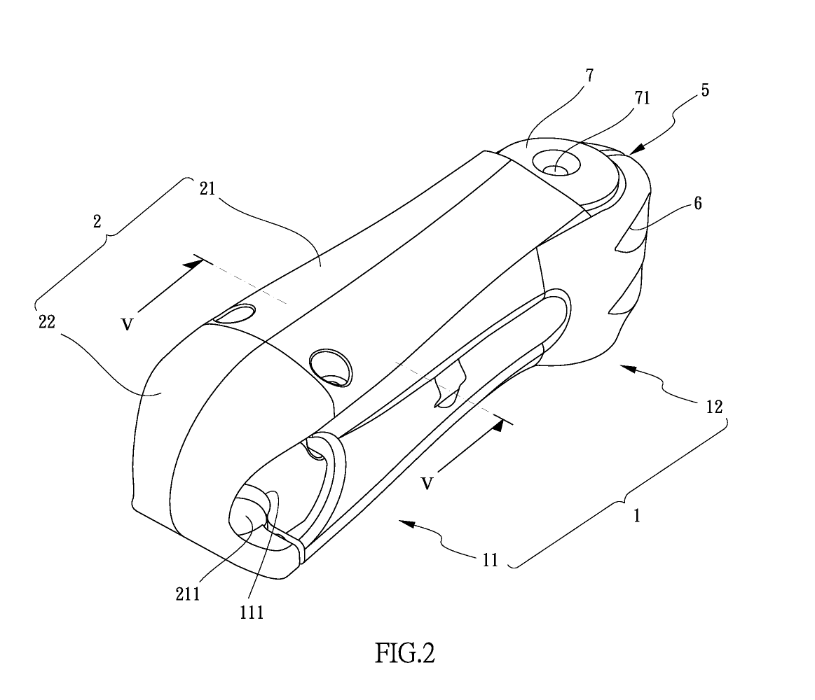

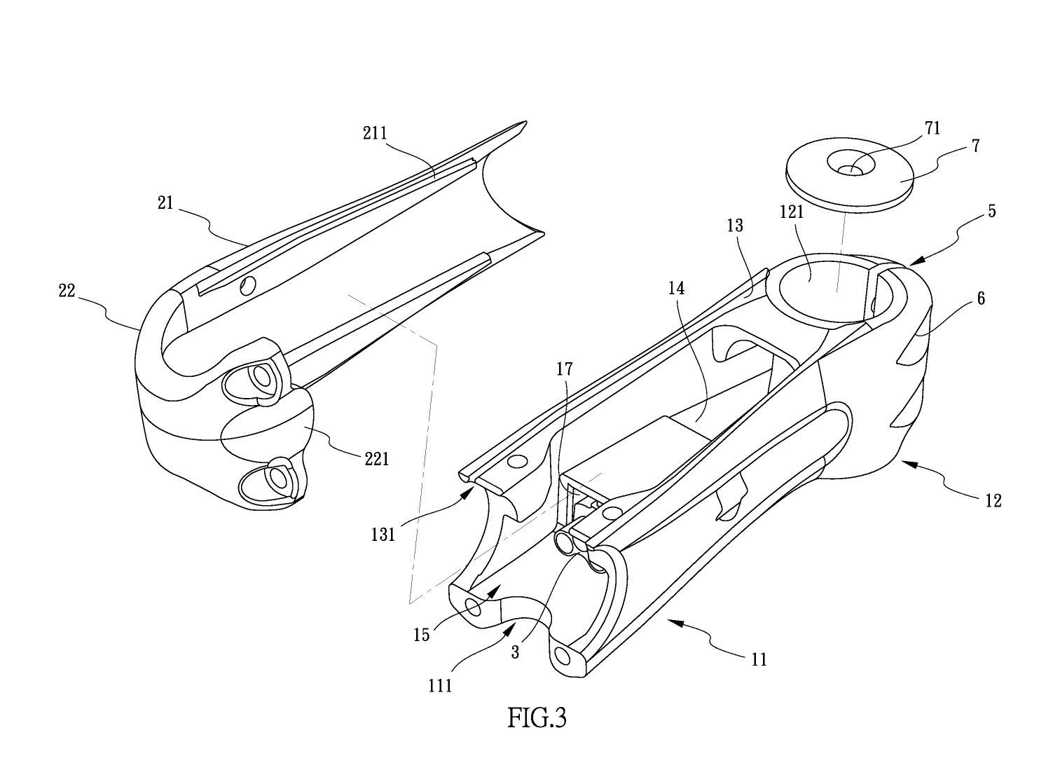

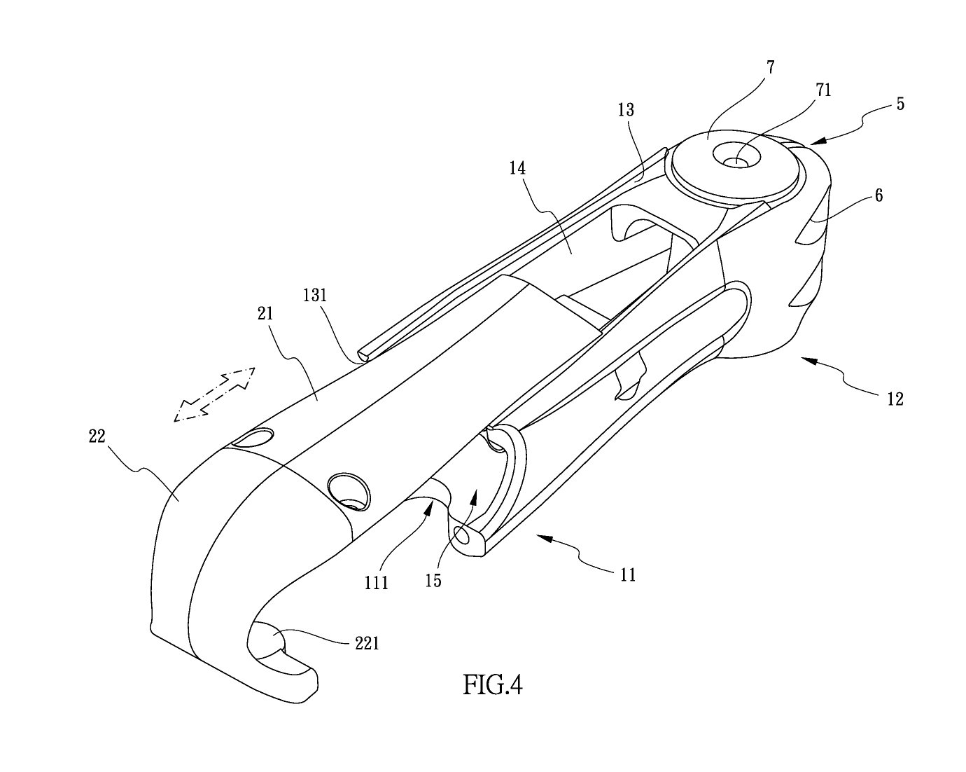

Referring to FIGS. 3-4, the clamping end 11 of the body 1 defines a positioning notch 111 at a lower edge thereof. The hook grip portion 22 of the clamping member 2 has a bump 221 protruding from the other end thereof which fits in the positioning notch 111 of the clamping end 11 of the body 1 so as to retain the clamping member 2 on the body 1, as shown in FIG. 2.

The bicycle stem of the present invention is provided for a user to assemble the handlebar 10 to the steering tube 20 conveniently. In operation, the body 1 is mounted on the steering tube 20 firstly and then the hook grip portion 22 of the clamping member 2 cooperates with the clamping end 11 of the body 1 to clamp the handlebar 10 and be secured by fasteners. More specifically, the clamping member 2 could be slidably mounted on the body 1 beforehand so that the hook grip portion 22 of the clamping member 2 could be adjusted relative to the clamping end 11 of the body 1, as shown in FIG. 4; therefore, the user could quickly assemble the handlebar 10 to the body 1.

As shown in FIG. 3 and referring to FIG. 1, the body 1 has a receiving groove 14 defined in the top thereof, wherein the receiving groove 14 of the body 1 could be covered by the blade portion 21 of the clamping member 2. The receiving groove 14 of the body 1 has an opening 15 at the clamping end 11 of the body 1. The receiving groove 14 of the body 1 is provided to accommodate an electronic device 3 which is equipped to the bicycle. Specifically, the blade portion 21 of the clamping member 2 and the body 1 together define a passage 16 therebetween at the connecting end 12 of the body 1 and communicating with the receiving groove 14 of the body 1, as shown in FIG. 1. Therefore, a wire 31 of the electronic device 3 could pass through the passage 16, as shown in FIG. 8.

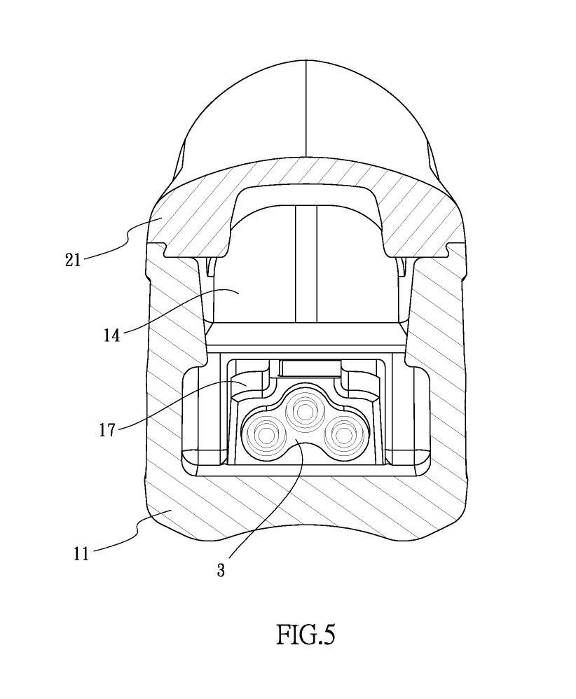

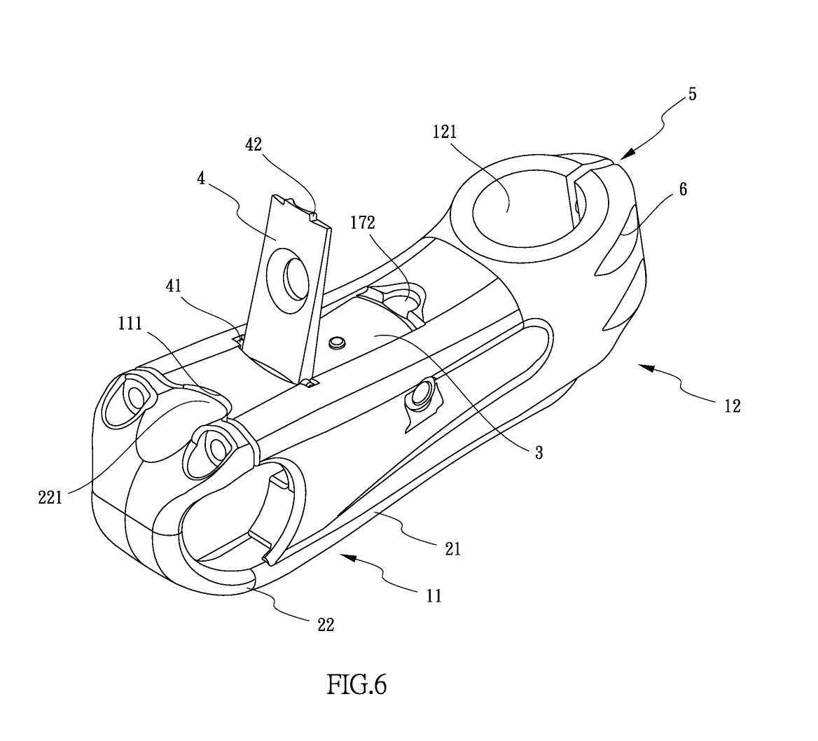

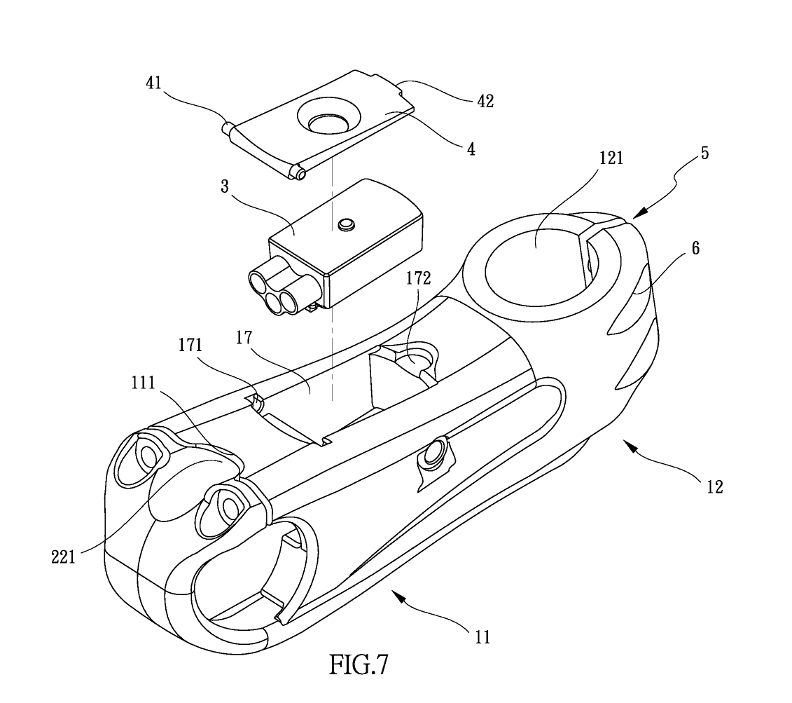

Referring to FIGS. 5-7, the body 1 further has a cavity 17 defined in a bottom thereof and communicating with the receiving groove 14 of the body 1. The electronic device 3 could be received in the cavity 17 of the body 1, as shown in FIG. 5. Specifically, a lid member 4 is pivotally mounted on the bottom of the body 1 for covering the cavity 17, wherein the lid member 4 is formed with a pair of studs 41 on opposite sides thereof and the body 1 has a pair of pivot grooves 171 for accommodating the studs 41 of the lid member 4 so that the lid member 4 is pivotable relative to the body 1. Moreover, the lid member 4 has a projection 42 defined at a free edge thereof. The body 1 has a recess 172 corresponding to the projection 42 of the lid member 4 for lifting the lid member 4 easily. Therefore, the electronic device 3 could be equipped or replaced easily, as shown in FIG. 6

As shown in FIG. 1, the body 1 has a gap 5 vertically defined at the connecting end 12 and in communication with the through hole 121 of the connecting end 12 of the body 1. The connecting end 12 of the body 1 has a plurality of locking holes 6 transversely defined therethrough. The gap 5 and the through holes 121 are shrunk by fasteners so that the body 1 is fastened on the steering tube 20. Furthermore, a cap 7 is configured to cover the through hole 121 of the connecting end 12 of the body 1. The cap 7 has a retaining hole 71 for a fastener 8 passing through so that the cap 7 could be secured on the body 1, as shown in FIG. 8.

Although embodiments of this invention have been fully described with reference to the accompanying drawings, it is to be understood that various modifications can be made by those skilled in the art without departing from the scope of the invention as hereinafter claimed.

What is claimed is:

1. A bicycle stem, which is adapted to be mounted between a handlebar and a steering tube of a bicycle, comprising:
a body having a clamping end corresponding to the handlebar and a connecting end to be mounted on the steering tube, the connecting end of the body defining a through hole for accommodating the steering tube, the body defining a pair of sliding grooves in a top thereof and each extending from the clamping end to the connecting end, each of the sliding grooves having an inlet at the clamping end of the body; and
a clamping member having a hook grip portion and a blade portion extending from one end of the hook grip portion, the blade portion of the clamping member having a pair of sliding protrusions formed on a bottom and slid into the sliding grooves of the body so that the clamping member is slidable relative to the body, the hook grip portion of the clamping member cooperating with the clamping end of the body to clamp the handlebar.

2. The bicycle stem as claimed in claim 1, wherein the clamping end of the body defines a positioning notch at a lower edge thereof; and the hook grip portion of the clamping member has a bump protruding from the other end thereof which fits in the positioning notch of the clamping end of the body so as to retain the clamping member on the body.

3. The bicycle stem as claimed in claim 1, wherein the body has a receiving groove defined in the top thereof; the receiving groove of the body has an opening at the clamping end of the body; the blade portion of the clamping member and the body together define a passage therebetween at the connecting end of the body and communicating with the receiving groove of the body.

4. The bicycle stem as claimed in claim 3, wherein the body has a cavity defined in a bottom thereof and communicating with the receiving groove of the body.

5. The bicycle stem as claimed in claim 4 further comprising a lid member pivotally mounted on the bottom of the body for covering the cavity; wherein the lid member is formed with a pair of studs on opposite sides thereof; and the body has a pair of pivot grooves for accommodating the studs of the lid member so that the lid member is pivotable relative to the body.

6. The bicycle stem as claimed in claim 5, wherein the lid member has a projection defined at a free edge thereof; and the body has a recess corresponding to the projection of the lid member for lifting the lid member easily.

7. The bicycle stem as claimed in claim 1, wherein the body has a gap vertically defined at the connecting end and in communication with the through hole of the connecting end of the body; and the connecting end of the body further has a plurality of locking holes transversely defined therethrough.

8. The bicycle stem as claimed in claim 1 further comprising a cap covering the through hole of the connecting end of the body; and the cap has a retaining hole for a fastener passing through so that the cap is secured on the body.
